(19) United States
(12) Patent Application Publication
(10) Pub. No.: US 2018/0092034 A1
(43) Pub. Date: Mar. 29, 2018

(54) LOW POWER ENHANCEMENT WITH SERVICE PROXY AND LOW POWER WAKE UP RADIO

(71) Applicant: INTEL CORPORATION, SANTA CLARA, CA (US)

(72) Inventors: Po-Kai HUANG, Santa Clara, CA (US); Emily H. QI, Gig Harbor, WA (US); Minyoung PARK, Portland, OR (US)

(21) Appl. No.: 15/278,301

(22) Filed: Sep. 28, 2016

(51) Int. Cl. H04W 52/02; H04W 48/16; H04W 4/00

(52) U.S. Cl. CPC H04W 52/0229; H04W 88/02; H04W 4/008; H04W 48/16

(57) ABSTRACT

One exemplary embodiment combines the concept of a LP-WUR (Low Power Wake Up Radio) and an improved service proxy to facilitate the low power service discovery operation. Specifically, a station (or in general any number of stations) can register to the proxy device for advertisement, with the station(s) then going into to the low power radio mode that uses the LP-WUR. The service proxy can advertise on behalf of the station(s) optionally without advertising a further schedule. If the service proxy receives a request from a neighboring device (e.g., another station) for the service of the registered station(s), the service proxy can then wake up one or more of the registered station(s) by transmitting a wakeup packet to the registered station so that the registered station can then advertise its service and schedule to connect with the neighboring device (e.g., the another station).

### TECHNICAL FIELD

An exemplary aspect is directed toward communications systems. More specifically an exemplary aspect is directed toward wireless communications systems and even more specifically to low-power wake-up radios and the associated power management and power savings in wireless communications systems.

### BACKGROUND

Wireless networks are ubiquitous and are commonplace indoors and outdoors and in shared locations. Wireless networks transmit and receive information utilizing varying techniques and protocols. For example, but not by way of limitation, common and widely adopted techniques used for communication are those that adhere to the Institute for Electronic and Electrical Engineers (IEEE) 802.11 standards such as the IEEE 802.11n standard, the IEEE 802.11ac standard and the IEEE 802.11ax standard.

The IEEE 802.11 standards specify a common Medium Access Control (MAC) Layer which provides a variety of functions that support the operation of IEEE 802.11-based Wireless LANs (WLANs) and devices. The MAC Layer manages and maintains communications between IEEE 802.11 stations (such as between radio network interface cards (NIC) in a PC or other wireless device(s) or stations (STA) and access points (APs)) by coordinating access to a shared radio channel and utilizing protocols that enhance communications over a wireless medium.

IEEE 802.11ax is the successor to IEEE 802.11ac and is proposed to increase the efficiency of WLAN networks, especially in high density areas like public hotspots and other dense traffic areas. IEEE 802.11ax also uses orthogonal frequency-division multiple access (OFDMA), and related to IEEE 802.11ax, the High Efficiency WLAN Study Group (HEW SG) within the IEEE 802.11 working group is considering improvements to spectrum efficiency to enhance system throughput/area in high density scenarios of APs (Access Points) and/or STAs (Stations).

Bluetooth® is a wireless technology standard adapted to exchange data over, for example, short distances using short-wavelength UHF radio waves in the ISM band from 2.4 to 2.485 GHz. Bluetooth® is commonly used to communicate information from fixed and mobile devices and for building personal area networks (PANs). Bluetooth® Low Energy (BLE), also known as Bluetooth® Smart®, utilizes less power than Bluetooth® but is able to communicate over the same range as Bluetooth®.

Wi-Fi (IEEE 802.11) and Bluetooth® are somewhat complementary in their applications and usage. Wi-Fi is usually access point-centric, with an asymmetrical client-server connection with all traffic routed through the access point (AP), while Bluetooth® is typically symmetrical, between two Bluetooth® devices. Bluetooth® works well in simple situations where two devices connect with minimal configuration like the press of a button, as seen with remote controls, between devices and printers, and the like. Wi-Fi tends to operate better in applications where some degree of client configuration is possible and higher speeds are required, especially for network access through, for example, an access node. However, Bluetooth® access points do exist and ad-hoc connections are possible with Wi-Fi though not as simply configured as Bluetooth®.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a Low-Power Wake-Up Radio (LP-WUR);

FIG. 2 illustrates an exemplary station to proxy communication;

FIG. 3 illustrates an exemplary proxy between stations;

FIG. 4 illustrates a functional block diagram of a wireless device, such as a mobile device;

FIG. 5 illustrates a hardware block diagram of an exemplary wireless device, such as a mobile device; and

FIG. 6 is a flowchart illustrating an exemplary method for operation for a proxy service.

### DESCRIPTION OF EMBODIMENTS

Mobile platform power management is one critical aspect of battery-powered small form factor platforms such as smartphones, tablets, wearables and IoT (Internet of Things) devices. Most mobile platform workloads are communication driven and the wireless radio is typically one of the main sources of the platform's power consumption.

Small computing devices such as wearable devices and sensors, mobile devices, Internet of Things (IoT) devices, and the like, are also all constrained by their small battery capacity/size, but still need to support wireless communication technologies such as Wi-Fi, Bluetooth®, Bluetooth® Low Energy (BLE), and/or the like, or in general any wireless technology. The wireless connectivity can be used to connect to other computing devices, such as smartphones, tablets, computers, the cloud, and the like, and exchange data. These communications consume power and it is critical to reduce, minimize or optimize energy consumption for such communications in these devices.

One strategy to minimize energy consumption is to turn the power off to the communication block as much/often as possible while maintaining data transmission and reception—without a corresponding increase in latency. Ideally the system could power on the communications block only when there is data to transmit and wake-up the communications block just before data reception, and power off the communications block for the remainder of the time.

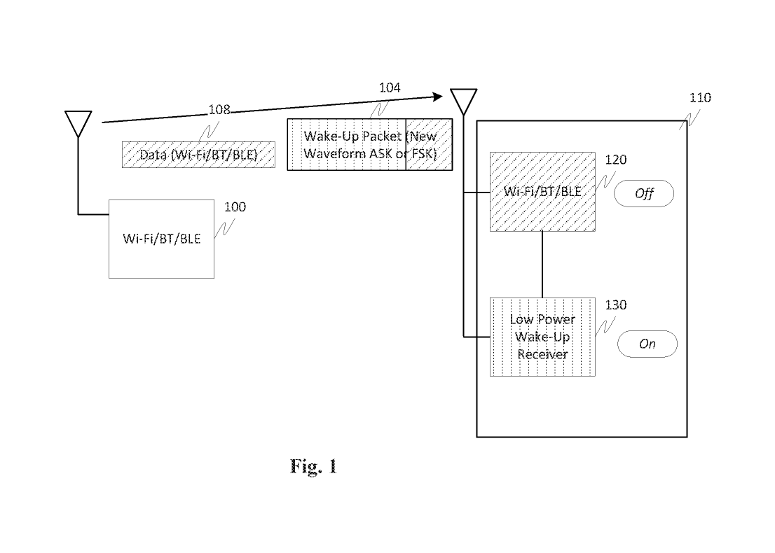

To address this issue, a radio architecture in which a specially designed low-power (e.g., with ˜50 μW active power or less) wake-up radio (LP-WUR) is used along with a main wireless radio (e.g., Wi-Fi, BT and/or BLE). Here the “main” radio wakes up only when the main radio has data to send to or receive from another radio (e.g., a Wi-Fi AP), as shown in FIG. 1. For example, when the AP 100 has data to send to the Wi-Fi device 110 (e.g., smartphone), the AP 100 will send a wake-up signal to the LP-WUR, which in turn wakes up the main (Wi-Fi/BT/BLE) radio 120.

Use of the low-power wake-up radio (LP-WUR) significantly reduces the power consumption of the main wireless radio(s) (e.g., Wi-Fi, Bluetooth, LTE, etc.) by removing the need for the main radio to periodically wake up to check if there is data to receive. As shown in FIG. 1, the LP-WUR allows a very low power method/technology to activate a main radio(s) only when there is data being sent specifically targeting that radio/device. The main radio could be any currently known radio, Wi-Fi, Bluetooth®, LTE, 5G, etc., or any future developed radio.

One exemplary advantage of the LP-WUR technology in that it helps with minimizing/reducing power consumption by one or more radios through use of the low-power wake-up radio.

An exemplary target device that can use the proposed technology is a device where a main radio is a radio that is capable of, for example, higher data rates than that of the LP-WUR, and typically consumes more power. This radio will henceforth be referred to as the “main” radio for explanation purposes.

As illustrated in FIG. 1, one way to realize this operational transmit/receive strategy is to have a low-power wake-up receiver/radio (LP-WUR) that can wake-up the main radio, such as a Wi-Fi, Bluetooth® radio, BLE radio, only when there is data to receive/transmit. (See FIG. 1 where the Wi-Fi/BT/BLE radio 120 (main radio) is off and the low power wake-up receiver 130 is on until data from the AP 100 is received). Research suggests the power consumption of such low-power wake-up radios (LP-WUR) can be less than 50 microwatts as discussed above.

When the wake-up packet 104 is received from the AP 100, the LP-WUR 130 wakes-up the Wi-Fi/BT/BLE radio 120, so that a data packet 108 that follows the wake-up packet from the AP can be received correctly. In some cases however, the actual data or an IEEE 802.11 MAC frame can be included in the wake-up packet. In this case, there is no need to wake-up the whole Wi-Fi/BT/BLE radio, but just a portion of the Wi-Fi/BT/BLE radio needs to be woken up to do the necessary processing. This can lead to additional significant power savings.

One exemplary advantage of the LP-WUR is to utilize an extremely low power radio such that a device (such as a wireless device) can be in a listening mode with minimum capability and consume extremely low power. If a main radio is required for user data (or other data) transmission, a wakeup packet will be sent by a peer device to wake up the main radio.

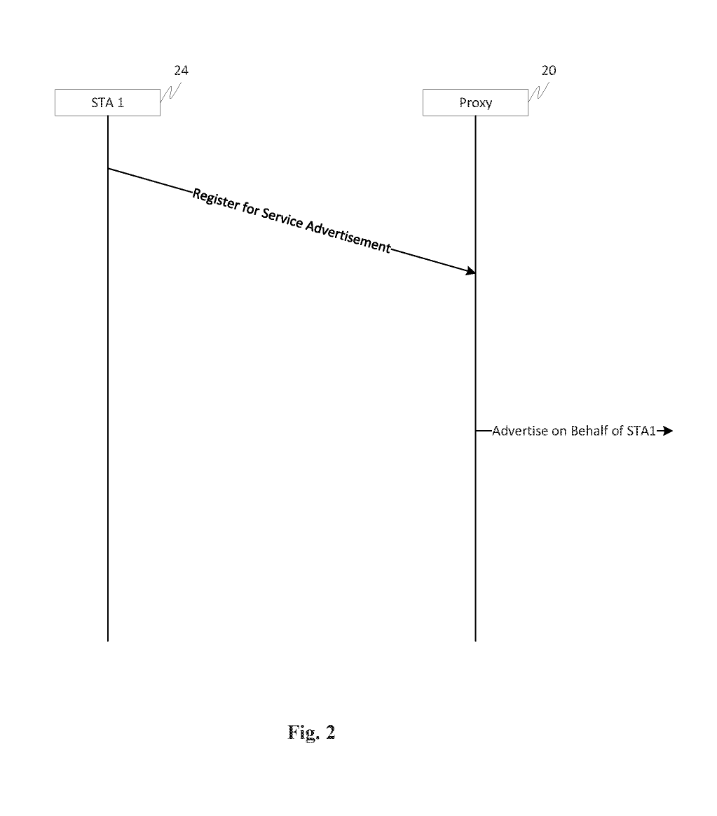

In accordance with one exemplary embodiment, a service proxy technology is introduced as shown in FIG. 2. The service proxy creates a proxy device 20 (e.g., a “Proxy Server”) that can help a neighboring device 24 to advertise service. The neighboring device (i.e., a Proxy Client) only need to register to the proxy device, and the proxy device can then advertise on behalf of the neighboring device(s).

While the concept of service proxy has been proposed in NAN2 in Wi-Fi Alliance (WFA), the proxy client is still required to wake up periodically in case some devices are interested in the service that it provides, which consumes power.

Neighbor awareness networks (NAN) allow wireless devices in near proximity to perform data exchanges directly over the NAN (e.g., without requiring the use of wireless carriers, Wi-Fi access points, other networks, etc.). The data exchange between the wireless devices in the NAN can occur through use of a wireless network that employs one or more IEEE 802.11 protocols. For example, a NAN using specific IEEE 802.11 protocols (such as IEEE 802.11a, IEEE 802.11b, IEEE 802.11g, IEEE 802.11n, IEEE 802.11ac, IEEE 802.11ad, IEEE 802.11ax, etc.) may support data transfer over one or more of a 2.4 GHz or 5 GHz frequency band. When a wireless device enters a NAN service area, the wireless device may activate a 2.4/5 GHz transceiver to determine whether a NAN is available for communications. NAN protocols provide for the periodic broadcast of a discovery beacon which informs wireless devices coming into the NAN area when the next NAN discovery window occurs. During the discovery window, wireless devices identify other wireless devices in the NAN, identify services provided by wireless devices in the NAN, transfer data to other wireless devices in the NAN, or schedule other data transfers (e.g., a data transfers after the discovery window, etc.). Discovery beacons are typically transmitted approximately 100 ms to 200 ms apart. Thus, a wireless device may activate a 2.4 GHz or a 5 GHz transceiver for at least 200 ms to listen for a discovery beacon and identify whether a NAN is available for communications. The 2.4 GHz and/or the 5 GHz transceivers have radios and associated equipment that consume significant amounts of operational power. Therefore, operating the 2.4 GHz or the 5 GHz transceiver results in high power consumption and associated reduction of battery power.

To use the service proxy, a device, say STA1, needs to advertise a specific wakeup schedule to the proxy device so that if a neighboring device hears the proxy device's advertisement on behalf of STA1, the neighboring device can then contact STA1 directly when STA1 is awake. However, STA1 then needs to periodically wake up even if there is no device that wants to contact STA1. This increases the power consumption of STA1.

One exemplary embodiment combines the concept of a LP-WUR (Low Power Wake Up Radio) and an improved service proxy to facilitate the low power service discovery operation.

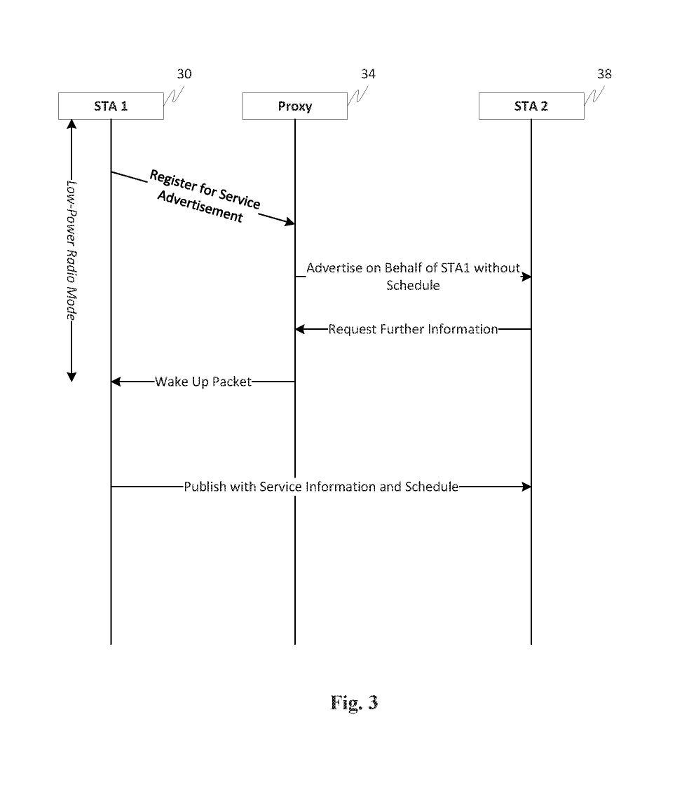

Specifically, and as shown in FIG. 3, STA1 30 (or in general any number of stations) can register to the proxy device 34 for advertisement, with STA1 30 then going into to the low power radio mode that uses the LP-WUR. The service proxy 34 can advertise on behalf of STA1 30 without advertising a further schedule.

If the service proxy 34 receives a request from a neighboring device 38 (e.g., STA2) for the service of STA1 30, the service proxy 34 can then wake up STA1 30 by transmitting a wakeup packet to STA1 30 so that STA1 30 can then advertise its service and schedule to have connection with the neighboring device 38 (e.g., STA2).

Note that the exemplary embodiment can optionally be used for any radio with the service proxy capability and low power wake up radio capability. While the exemplary embodiments are by no means limited to Wi-Fi radio or Wi-Fi Aware, Wi-Fi radio and Wi-Fi Aware are obvious applications for this technology.

Although the service proxy technique in NAN2 saves power for the service discovery procedure, as discussed, the proxy client still has to periodically wake up to check if there are any neighboring devices requesting a service, which consumes power.

One exemplary embodiment combines the concept of LP-WUR and service proxy so that a proxy client can stay in a low power mode until the proxy server transmits a wakeup packet to indicate that there is a service request from a neighboring device, which eliminates the need to wake up periodically and minimizes power consumption of the proxy client while, at the same time providing a service to the neighboring device with minimum latency.

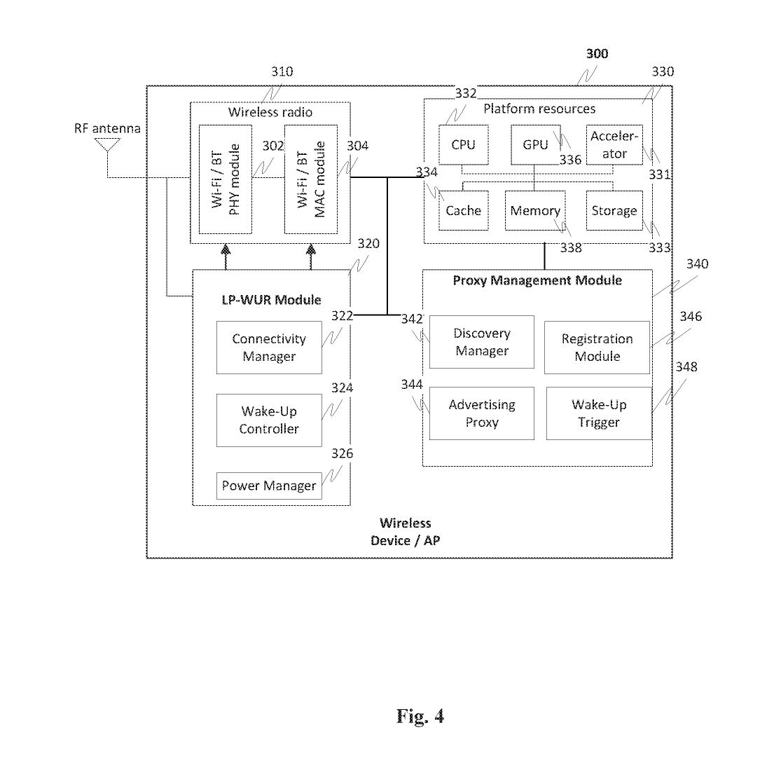

FIG. 4 illustrates an exemplary functional block diagram of a wireless device 300, such as a mobile device, that can be used with any one or more of the aspects disclosed herein. In particular, this exemplary architecture, where well-known components have been omitted for clarity, allows the LP-WUR module 320 to one or more of improve connectivity management and save power in the device 300 and optionally in one or more various platform resources 330.

More specifically, FIG. 4 illustrates an exemplary wireless/mobile device/AP 300 that includes a wireless radio 310, which includes a Wi-Fi/Bluetooth® (BT)BLE PHY module 302, a Wi-Fi/BT/BLE MAC module 304, an LP-WUR module 320, and one or more interconnected platform resources 330, such as CPU 332, cache 334, GPU 336, memory 338, accelerator 331 and storage 333. Optionally, the LP-WUR module 320 may have its own demodulator, antenna, etc., to complement its low-power operation.

In addition, the wireless/mobile device 300 includes a connectivity manager 322, a wake-up controller 324 and a power manager 326. The wireless/mobile device 300 also includes a proxy management module 340 which includes a discovery manager 342, an advertising proxy 344, a registration module 346 and wake-up trigger 348. The mobile device 300 can also include one or more sensors (not shown) such as an accelerometer, gyroscope, GPS, Wi-Fi location determination module, and in general any device(s) capable of determining a position or change in position of the device.

In accordance with one exemplary embodiment, the presence of the LP-WUR is leveraged to one or more of improve latency and reduce power consumption. More specifically, the LP-WUR module 320 maintains connectivity to the AP without waking up the main radio 310. The AP can transmit wake-up packets with partial beacon information to the associated stations equipped with LP-WURs. When the wake-up packets are periodically received, the station “knows” that the AP is still within transmission range. Otherwise, if the periodic wake-up packets are not received, the station “knows” or detects that the AP is outside of the transmission range with this information being communicable to the main wireless radio 310 by the wake-up controller 324 and connectivity manager 322. This allows the power manager 326 to keep the main radio 310 in a sleep state, or turned off, for a longer period of time and maximize the radio/platform power saving without risking disconnection from the AP for a longer period of time.

An exemplary operation of the client-server type of relationship for stations and the proxy are as follows (with comparable equipment to that shown in FIG. 4 present in each of the devices):

A device with the low power wake up radio (LP-WUR) capability discovers a peer device with the LP-WUR capability using the discovery manager 342, and that also has proxy capability, and registers to the peer device. The peer device becomes a proxy device. This registration can be accomplished through a registration process with an exchange of information. As an example, the registration can be a frame exchange registration process that includes information such as device identification information, LP-WUP information, proxy capabilities (if any), service information, schedule information, publish message information, and in general any information useful to accomplish one or more of the various tasks described herein. The information related to one or more services that can be provided by the device can also be included in the frame exchange of the registration process.

One registration is complete, at the registration module 346, with the peer device acting as the proxy server optionally acknowledges registration of the client device, with the proxy (server) device and advertising proxy 344 advertising on behalf of the registered (client) device.

The proxy device and advertising proxy 344 may optionally send a specific publish message(s) with information provided by the registered device to advertise on behalf of the registered device (e.g., an unsolicited publish). Alternatively, the proxy device may not send a specific publish message, but rather simply wait for a request from a neighboring device to request for further information (i.e., a solicited publish).

After the proxy device receives, at the wake-up trigger 348, a request based on its publish message or receives a request for specific information that matches the information provided by the registered device, the proxy device sends from the wake-up trigger a wakeup packet to wake up the corresponding registered device(s).

The wakeup packet sent to the registered device(s) may optionally include an indication of the information that the neighboring device is searching for.

Upon receiving the wakeup packet at the registered device, the LP-WUR 320, 322, 324, 326, of the registered device wakes up the main radio(s) 310 (e.g., IEEE 802.11 radio/Bluetooth,® etc.) and the registered device sends a publish message with the information that was requested by the neighboring device. The registered device can also forward scheduling information for the neighboring device to allow further communications.

Once the main radio 310 of the registered device is active, the LP-WUR 320 may be turned off to save power, and the registered device can have a “normal” frame exchange with the neighboring device (e.g., following the NAN2 (neighboring area network) standard operation) (as if it is not equipped with the LP-WUR).

After the completion of the service, and if there are no other service(s) to provide, the registered device can turn off the main radio 310 and turn on the LP-WUR 320 and go into the low power radio mode. The registered device can also optionally inform the proxy device via the registration module 346 that it is re-entering the LP-WUR mode and that the proxy device should (again) listen on its behalf.

An exemplary embodiment can also directly apply to the NAN2 device, i.e., Wi-Fi aware device, if the NAN2 device has the LP-WUR capability, when there is an existing service proxy with LP-WUR wake up capability.

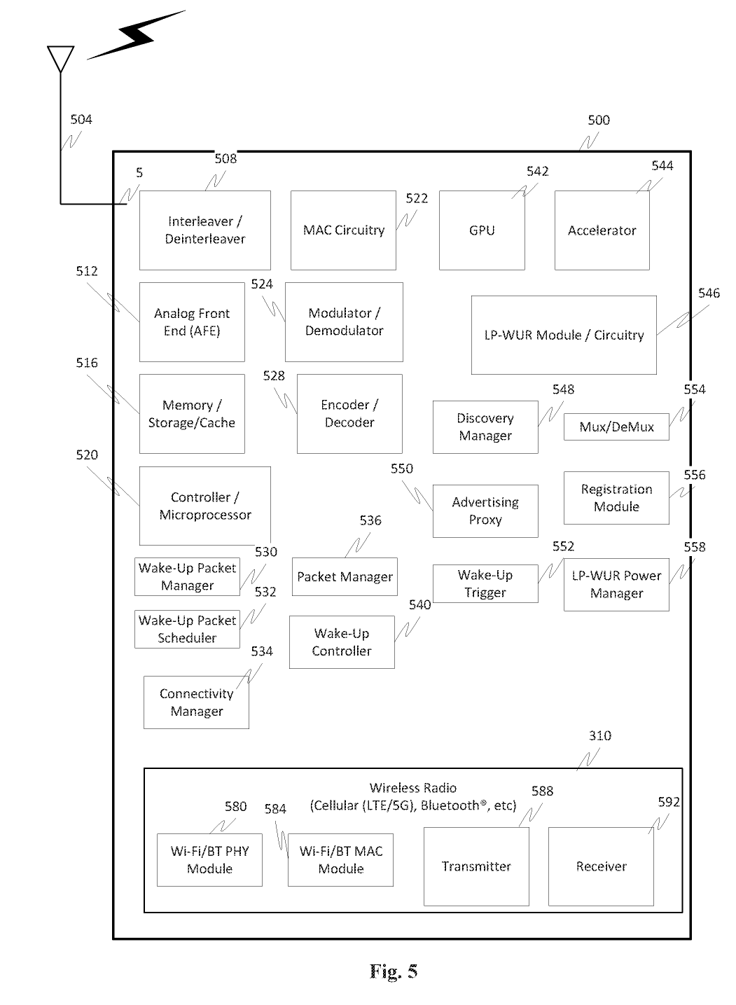

FIG. 5 illustrates an exemplary hardware diagram of a device 500, such as a wireless device, mobile device, access point, station, or the like, that is adapted to implement the technique(s) discussed herein. As with FIG. 4, operation will be discussed in relation to the components in FIG. 5 appreciating that each separate device, e.g., station, AP, proxy server, etc., can include one or more of the optional components shown in the figure.

In addition to well-known componentry (which has been omitted for clarity), the device 500 includes interconnected elements (with links 5 omitted for clarity) including one or more of: one or more antennas 504, an interleaver/deinterleaver 508, an analog front end (AFE) 512, memory/storage/cache 516, controller/microprocessor 520, MAC circuitry 522, modulator/demodulator 524, encoder/decoder 528, a wake-up packet manager 530, a wake-up packet scheduler 532, a connectivity manager 534, a packet manager 536, a discovery manager 548, a wake-up controller 540, GPU 542, accelerator 444, a LP-WUR module and/or circuitry 546, a multiplexer/demultiplexer 54, an advertising proxy 550, a wake-up trigger 552, a registration module 556, a LP-WUR power manager 558, and wireless radio 310 components such as a Wi-Fi PHY module 580, a Wi-Fi/BT MAC module 584, transmitter 588 and receiver 592. The various elements in the device 500 are connected by one or more links (not shown, again for sake of clarity).

The device 500 can have one more antennas 504, for use in wireless communications such as multi-input multi-output (MIMO) communications, multi-user multi-input multi-output (MU-MIMO) communications Bluetooth®, LTE, etc. The antenna(s) 504 can include, but are not limited to one or more of directional antennas, omnidirectional antennas, monopoles, patch antennas, loop antennas, microstrip antennas, dipoles, and any other antenna(s) suitable for communication transmission/reception. In an exemplary embodiment, transmission/reception using MIMO may require particular antenna spacing. In another exemplary embodiment, MIMO transmission/reception can enable spatial diversity allowing for different channel characteristics at each of the antennas. In yet another embodiment, MIMO transmission/reception can be used to distribute resources to multiple users.

Antenna(s) 504 generally interact with the Analog Front End (AFE) 512, which is needed to enable the correct processing of the received modulated signal and signal conditioning for a transmitted signal. The AFE 512 can be functionally located between the antenna and a digital baseband system in order to convert the analog signal into a digital signal for processing and vice-versa.

The device 500 can also include a controller/microprocessor 520 and a memory/storage/cache 516. The device 500 can interact with the memory/storage/cache 516 which may store information and operations necessary for configuring and transmitting or receiving the information described herein. The memory/storage/cache 516 may also be used in connection with the execution of application programming or instructions by the controller/microprocessor 520, and for temporary or long term storage of program instructions and/or data. As examples, the memory/storage/cache 520 may comprise a computer-readable device, RAM, ROM, DRAM, SDRAM, and/or other storage device(s) and media.

The controller/microprocessor 520 may comprise a general purpose programmable processor or controller for executing application programming or instructions related to the device 500. Furthermore, the controller/microprocessor 520 can perform operations for configuring and transmitting information as described herein. The controller/microprocessor 520 may include multiple processor cores, and/or implement multiple virtual processors. Optionally, the controller/microprocessor 520 may include multiple physical processors. By way of example, the controller/microprocessor 520 may comprise a specially configured Application Specific Integrated Circuit (ASIC) or other integrated circuit, a digital signal processor(s), a controller, a hardwired electronic or logic circuit, a programmable logic device or gate array, a special purpose computer, or the like.

The device 500 can further include a transmitter 588 and receiver 592 which can transmit and receive signals, respectively, to and from other wireless devices and/or access points using the one or more antennas 504. Included in the device 500 circuitry is the medium access control or MAC Circuitry 522. MAC circuitry 522 provides for controlling access to the wireless medium. In an exemplary embodiment, the MAC circuitry 522 may be arranged to contend for the wireless medium and configure frames or packets for communicating over the wireless medium.

The device 500 can also optionally contain a security module (not shown). This security module can contain information regarding but not limited to, security parameters required to connect the device to an access point or other device or other available network(s), and can include WEP or WPA/WPA-2 (optionally+AES and/or TKIP) security access keys, network keys, etc. The WEP security access key is a security password used by Wi-Fi networks. Knowledge of this code can enable a wireless device to exchange information with the access point and/or another device. The information exchange can occur through encoded messages with the WEP access code often being chosen by the network administrator. WPA is an added security standard that is also used in conjunction with network connectivity with stronger encryption than WEP.

As shown in FIG. 5, the exemplary device 500 also includes a GPU 542, an accelerator 544, a LP-WUR module and/or circuitry 546 a Wi-Fi/BT/BLE PHY module 580 and a Wi-Fi/BT/BLE MAC module 584 that at least cooperate with the LP-WUR module 546 and one or more of mux/demux 554, wake-up packet manager 530, wake-up packet scheduler 532, connectivity manager 534, packet manager 536, proxy and registration components and the wake-up controller 540 to achieve at least the more efficient operation as discussed herein.

In accordance with an exemplary operational embodiment, a device with the low power wake up radio (LP-WUR) capability (such as device 30 in FIG. 3) discovers a peer device, using the discovery manager 548, with a LP-WUR capability (such as device 34 in FIG. 3), and that also has proxy capability (provided by the advertising proxy 550), and registers to the peer device via the registration module 556. The peer device (such as device 34 in FIG. 3) becomes a proxy device. This registration can be accomplished through a registration process with an exchange of information. As an example, the registration can be a frame exchange registration process that includes information such as device identification information, LP-WUP information, proxy capabilities (if any), service information, schedule information, publish message information, and in general any information useful to accomplish one or more of the various tasks described herein as discussed.

One registration is complete, the registration module 346 (with the peer device acting as the proxy server optionally acknowledging registration of the client device) of the proxy (server) device advertises using the advertising proxy 550 on behalf of the registered (client) device to one or more other devices (such as device 38 in FIG. 3).

The proxy device and advertising proxy 550 may optionally send a specific publish message(s) with information provided by the registered device to advertise on behalf of the registered device (e.g., an unsolicited publish). Alternatively, the proxy device may not send a specific publish message, but rather simply wait for a request from a neighboring device to request for further information (i.e., a solicited publish).

After the proxy device receives, at the wake-up trigger 552, a request based on its publish message or receives a request for specific information that matches the information provided by the registered device, the proxy device sends from the wake-up trigger 552 and transmitter 588 a wakeup packet generated by the wake-up packet manager to wake up the corresponding registered device(s).

The wakeup packet sent to the registered device(s) may optionally include an indication of the information that the neighboring device is searching for and/or scheduling information provided by the wake-up packet scheduler 532.

Upon receiving the wakeup packet at the registered device, the LP-WUR 546, of the registered device wakes up the main radio(s) 310 (e.g., IEEE 802.11 radio/Bluetooth,® etc.) and the registered device sends a publish message with the information that was requested by the neighboring device. The registered device (such as device 30 in FIG. 3) can also forward scheduling information to the neighboring device (such as device 38 in FIG. 3) to allow further communications.

Once the main radio 310 of the registered device is active, the LP-WUR 546 may be turned off to save power, and the registered device can have a “normal” frame exchange with the neighboring device (e.g., following the NAN2 (neighboring area network) standard operation) (as if it is not equipped with the LP-WUR).

After the completion of the service, and if there are no other service(s) to provide, the registered device can turn off the main radio 310 and turn on the LP-WUR 546 and go into the low power radio mode. The registered device can also optionally inform the proxy device via the registration module 556 that it is re-entering the LP-WUR mode and that the proxy device should (again) listen on its behalf.

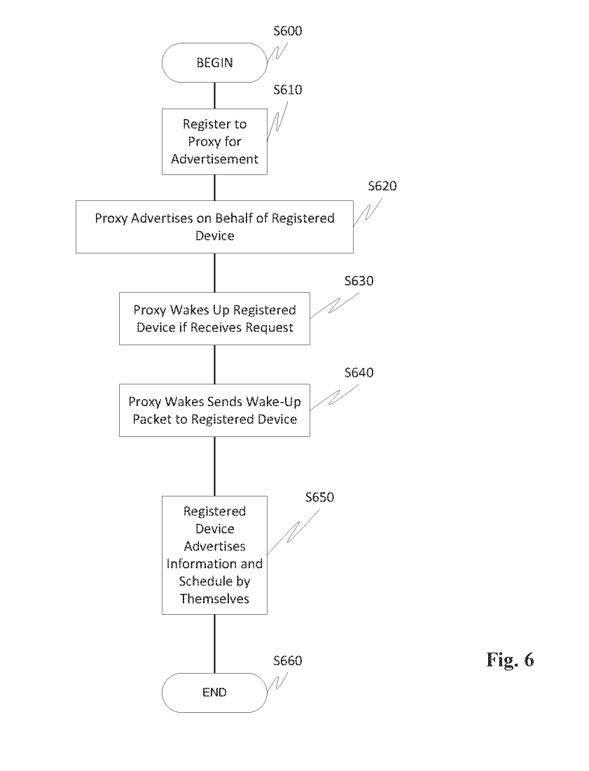

FIG. 6 outlines an exemplary technique for proxy advertising. Control begins in step S600 and continues to step S610. In step S610, a device with the low power wake up radio (LP-WUR) capability discovers a peer device with the LP-WUR capability and that also has proxy capability, and registers to the peer device. Next, in step S620, the peer device becomes a proxy device. This registration can be accomplished through a registration process with an exchange of information as discussed. One registration is complete, the proxy (server) device advertises on behalf of the registered (client) device. Control then continues to step S630.

In step S630, and after the proxy device receives a request based on its publish message or receives a request for specific information that matches the information provided by the registered device, the proxy device sends in step S640 a wakeup packet to wake up the corresponding registered device(s). The wakeup packet sent to the registered device(s) may optionally include an indication of the information that the neighboring device is searching for. Control then continues to step S650.

In step S650, and upon receipt of the wakeup packet at the registered device, the registered device wakes up the main radio(s) (e.g., IEEE 802.11 radio/Bluetooth,® etc.) and the registered device sends a publish message with the information that was requested by the neighboring device. The registered device can also forward scheduling information for the neighboring device to allow further communications in step S650. Control then continues to step S650 where the control sequence ends.

After the completion of the service, and if there are no other service(s) to provide, the registered device can optionally turn off the main radio and turn on the LP-WUR and go into the low power radio mode. The registered device can also optionally inform the proxy device that it is re-entering the LP-WUR mode and that the proxy device should (again) listen on its behalf.

In the detailed description, numerous specific details are set forth in order to provide a thorough understanding of the disclosed techniques. However, it will be understood by those skilled in the art that the present techniques may be practiced without these specific details. In other instances, well-known methods, procedures, components and circuits have not been described in detail so as not to obscure the present disclosure.

Although embodiments are not limited in this regard, discussions utilizing terms such as, for example, “processing,” “computing,” “calculating,” “determining,” “establishing”, “analysing”, “checking”, or the like, may refer to operation(s) and/or process(es) of a computer, a computing platform, a computing system, a communication system or subsystem, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, circuits, or the like. For example, “a plurality of stations” may include two or more stations.

It may be advantageous to set forth definitions of certain words and phrases used throughout this document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, interconnected with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, circuitry, firmware or software, or some combination of at least two of the same. It should be noted that the functionality associated with any particular controller may be centralized or distributed, whether locally or remotely. Definitions for certain words and phrases are provided throughout this document and those of ordinary skill in the art should understand that in many, if not most instances, such definitions apply to prior, as well as future uses of such defined words and phrases.

The exemplary embodiments will be described in relation to communications systems, as well as protocols, techniques, means and methods for performing communications, such as in a wireless network, or in general in any communications network operating using any communications protocol(s). Examples of such are home or access networks, wireless home networks, wireless corporate networks, and the like. It should be appreciated however that in general, the systems, methods and techniques disclosed herein will work equally well for other types of communications environments, networks and/or protocols.

For purposes of explanation, numerous details are set forth in order to provide a thorough understanding of the present techniques. It should be appreciated however that the present disclosure may be practiced in a variety of ways beyond the specific details set forth herein. Furthermore, while the exemplary embodiments illustrated herein show various components of the system collocated, it is to be appreciated that the various components of the system can be located at distant portions of a distributed network, such as a communications network, node, within a Domain Master, and/or the Internet, or within a dedicated secured, unsecured, and/or encrypted system and/or within a network operation or management device that is located inside or outside the network. As an example, a Domain Master can also be used to refer to any device, system or module that manages and/or configures or communicates with any one or more aspects of the network or communications environment and/or transceiver(s) and/or stations and/or access point(s) described herein.

Thus, it should be appreciated that the components of the system can be combined into one or more devices, or split between devices, such as a transceiver, an access point, a station, a Domain Master, a network operation or management device, a node or collocated on a particular node of a distributed network, such as a communications network. As will be appreciated from the following description, and for reasons of computational efficiency, the components of the system can be arranged at any location within a distributed network without affecting the operation thereof. For example, the various components can be located in a Domain Master, a node, a domain management device, such as a MIB, a network operation or management device, a transceiver(s), a station, an access point(s), or some combination thereof. Similarly, one or more of the functional portions of the system could be distributed between a transceiver and an associated computing device/system.

Furthermore, it should be appreciated that the various links 5, including the communications channel(s) connecting the elements, can be wired or wireless links or any combination thereof, or any other known or later developed element(s) capable of supplying and/or communicating data to and from the connected elements. The term module as used herein can refer to any known or later developed hardware, circuitry, software, firmware, or combination thereof, that is capable of performing the functionality associated with that element. The terms determine, calculate, and compute and variations thereof, as used herein are used interchangeable and include any type of methodology, process, technique, mathematical operational or protocol.

Moreover, while some of the exemplary embodiments described herein are directed toward a transmitter portion of a transceiver performing certain functions, or a receiver portion of a transceiver performing certain functions, this disclosure is intended to include corresponding and complementary transmitter-side or receiver-side functionality, respectively, in both the same transceiver and/or another transceiver(s), and vice versa.

The exemplary embodiments are described in relation to enhanced GFDM communications. However, it should be appreciated, that in general, the systems and methods herein will work equally well for any type of communication system in any environment utilizing any one or more protocols including wired communications, wireless communications, powerline communications, coaxial cable communications, fiber optic communications, and the like.

The exemplary systems and methods are described in relation to IEEE 802.11 and/or Bluetooth® and/or Bluetooth® Low Energy transceivers and associated communication hardware, software and communication channels. However, to avoid unnecessarily obscuring the present disclosure, the following description omits well-known structures and devices that may be shown in block diagram form or otherwise summarized.

Exemplary aspects are directed toward:

A wireless communications device comprising:

a discovery manager adapted to receive from a receiver a discovery request;

a registration module that receives the discovery request and registers station information for a device that sent the discovery request, wherein the registered station is allowed to enter a low-power mode using a low-power wake-up radio upon registration completion; and

an advertising proxy that communicates with a transmitter to advertise on behalf of the registered station.

Any one or more of the above aspects, further comprising a wake-up trigger which receives a request for further information from one or more other stations.

Any one or more of the above aspects, wherein the wake-up trigger causes a wake-up packet to be sent to the registered station.

Any one or more of the above aspects, wherein the device acts as an advertising proxy for the registered station.

Any one or more of the above aspects, wherein the device provides a low-power service discovery for the registered station.

Any one or more of the above aspects, further comprising one or more of an interleaver/deinterleaver, an analog front end, a modulator/demodulator, a GPU, an accelerator, an encoder/decoder, one or more antennas, a processor and memory.

Any one or more of the above aspects, further comprising one or more wireless radios.

Any one or more of the above aspects, further comprising a low-power wake-up radio power manager configured to control operation of a low-power wake-up radio.

Any one or more of the above aspects, configured to one or more of save power and improve connectivity for the registered station.

A non-transitory computer-readable information storage media, having stored thereon instructions, that when executed by a processor perform a wireless communication method, for a wireless communications device, comprising:

receiving from a receiver a discovery request from a low-power wake-up radio (LP-WUR) equipped device;

registering the LP-WUR equipped device, wherein the LP-WUR equipped device is allowed to enter a low-power mode using a low-power wake-up radio upon registration completion; and

advertising on behalf of the LP-WUR equipped device while the LP-WUR equipped device is in a low power mode.

Any one or more of the above aspects, further comprising receiving a request for further information from one or more other stations.

Any one or more of the above aspects, wherein a wake-up trigger causes a wake-up packet to be sent to the registered station.

Any one or more of the above aspects, wherein the device acts as an advertising proxy for the registered station.

Any one or more of the above aspects, wherein the device provides a low-power service discovery for the registered station.

Any one or more of the above aspects, further comprising communicating on one or more wireless radios.

Any one or more of the above aspects, further comprising controlling operation of a low-power wake-up radio.

Any one or more of the above aspects, wherein the device is configured to one or more of save power and improve connectivity for the LP-WUR equipped device.

A wireless communications device, comprising:

means for receiving from a receiver a discovery request from a low-power wake-up radio (LP-WUR) equipped device;

means for registering the LP-WUR equipped device, wherein the LP-WUR equipped device is allowed to enter a low-power mode using a low-power wake-up radio upon registration completion;

means advertising on behalf of the LP-WUR equipped device while the LP-WUR equipped device is in a low power mode; and

waking-up the LP-WUR equipped device when a request for further information is received for the LP-WUR equipped device.

A method for operating a wireless communications device comprising: receiving from a receiver a discovery request from a low-power wake-up radio (LP-WUR) equipped device;

registering the LP-WUR equipped device, wherein the LP-WUR equipped device is allowed to enter a low-power mode using a low-power wake-up radio upon registration completion;

advertising on behalf of the LP-WUR equipped device while the LP-WUR equipped device is in a low power mode; and

waking-up the LP-WUR equipped device when a request for further information is received for the LP-WUR equipped device.

A wireless communications system comprising:

a wireless device adapted to forward a discovery request;

a service proxy including a discovery manager adapted to receive from a receiver the discovery request;

a registration module in the service proxy that receives the discovery request and registers station information for the wireless device that sent the discovery request, wherein the wireless device is registered as a registered station and is allowed to enter a low-power mode using a low-power wake-up radio upon registration completion; and

an advertising proxy that communicates with a transmitter to advertise to one or more other wireless stations on behalf of the registered station.

Any one or more of the above aspects, further comprising a wake-up trigger which receives a request for further information from the one or more other wireless stations.

Any one or more of the above aspects, wherein the wake-up trigger causes a wake-up packet to be sent to the registered station.

Any one or more of the above aspects, wherein the service proxy is an advertising proxy for the registered station.

Any one or more of the above aspects, wherein the service proxy provides a low-power service discovery for the registered station.

Any one or more of the above aspects, wherein each of the wireless device and service proxy further comprise one or more of an interleaver/deinterleaver, an analog front end, a modulator/demodulator, a GPU, an accelerator, an encoder/decoder, one or more antennas, a processor and memory.

Any one or more of the above aspects, further comprising one or more wireless radios.

Any one or more of the above aspects, further comprising a low-power wake-up radio power manager configured to control operation of a low-power wake-up radio.

Any one or more of the above aspects, configured to one or more of save power and improve connectivity for the registered station.

A system on a chip (SoC) including any one or more of the above aspects.

One or more means for performing any one or more of the above aspects.

Any one or more of the aspects as substantially described herein.

For purposes of explanation, numerous details are set forth in order to provide a thorough understanding of the present embodiments. It should be appreciated however that the techniques herein may be practiced in a variety of ways beyond the specific details set forth herein.

Furthermore, while the exemplary embodiments illustrated herein show the various components of the system collocated, it is to be appreciated that the various components of the system can be located at distant portions of a distributed network, such as a communications network and/or the Internet, or within a dedicated secure, unsecured and/or encrypted system. Thus, it should be appreciated that the components of the system can be combined into one or more devices, such as an access point or station, or collocated on a particular node/element(s) of a distributed network, such as a telecommunications network. As will be appreciated from the following description, and for reasons of computational efficiency, the components of the system can be arranged at any location within a distributed network without affecting the operation of the system. For example, the various components can be located in a transceiver, an access point, a station, a management device, or some combination thereof. Similarly, one or more functional portions of the system could be distributed between a transceiver, such as an access point(s) or station(s) and an associated computing device.

Furthermore, it should be appreciated that the various links, including communications channel(s), connecting the elements (which may not be not shown) can be wired or wireless links, or any combination thereof, or any other known or later developed element(s) that is capable of supplying and/or communicating data and/or signals to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

While the above-described flowcharts have been discussed in relation to a particular sequence of events, it should be appreciated that changes to this sequence can occur without materially effecting the operation of the embodiment(s). Additionally, the exact sequence of events need not occur as set forth in the exemplary embodiments, but rather the steps can be performed by one or the other transceiver in the communication system provided both transceivers are aware of the technique being used for initialization. Additionally, the exemplary techniques illustrated herein are not limited to the specifically illustrated embodiments but can also be utilized with the other exemplary embodiments and each described feature is individually and separately claimable.

The above-described system can be implemented on a wireless telecommunications device(s)/system, such an IEEE 802.11 transceiver, or the like. Examples of wireless protocols that can be used with this technology include IEEE 802.11a, IEEE 802.11b, IEEE 802.11g, IEEE 802.11n, IEEE 802.11ac, IEEE 802.11ad, IEEE 802.11af, IEEE 802.11ah, IEEE 802.11ai, IEEE 802.11aj, IEEE 802.11aq, IEEE 802.11ax, Wi-Fi, LTE, 4G, Bluetooth®, WirelessHD, WiGig, WiGi, 3GPP, Wireless LAN, WiMAX, and the like.

The term transceiver as used herein can refer to any device that comprises hardware, software, circuitry, firmware, or any combination thereof and is capable of performing any of the methods, techniques and/or algorithms described herein.

Additionally, the systems, methods and protocols can be implemented to improve one or more of a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a modem, a transmitter/receiver, any comparable means, or the like. In general, any device capable of implementing a state machine that is in turn capable of implementing the methodology illustrated herein can benefit from the various communication methods, protocols and techniques according to the disclosure provided herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, Broadcom® AirForce BCM4704/BCM4703 wireless networking processors, the AR7100 Wireless Network Processing Unit, other industry-equivalent processors, and may perform computational functions using any known or future-developed standard, instruction set, libraries, and/or architecture.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with the embodiments is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and telecommunications arts.

Moreover, the disclosed methods may be readily implemented in software and/or firmware that can be stored on a storage medium to improve the performance of: a programmed general-purpose computer with the cooperation of a controller and memory, a special purpose computer, a microprocessor, or the like. In these instances, the systems and methods can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications transceiver.

It is therefore apparent that there has at least been provided systems and methods for enhanced communications and power consumption reduction. While the embodiments have been described in conjunction with a number of embodiments, it is evident that many alternatives, modifications and variations would be or are apparent to those of ordinary skill in the applicable arts. Accordingly, this disclosure is intended to embrace all such alternatives, modifications, equivalents and variations that are within the spirit and scope of this disclosure.

1. A wireless communications device comprising:
a discovery manager adapted to receive from a receiver a discovery request;
a registration module that receives the discovery request and registers station information for the device that sent the discovery request, wherein the registered station is allowed to enter a low-power mode using a low-power wake-up radio upon registration completion; and
an advertising proxy that communicates with a transmitter to advertise on behalf of the registered station.

2. The device of claim 1, further comprising a wake-up trigger which receives a request for further information from one or more other stations.

3. The device of claim 2, wherein the wake-up trigger causes a wake-up packet to be sent to the registered station.

4. The device of claim 1, wherein the device acts as an advertising proxy for the registered station.

5. The device of claim 1, wherein the device provides a low-power service discovery for the registered station.

6. The device of claim 1, further comprising one or more of an interleaver/deinterleaver, an analog front end, a modulator/demodulator, a GPU, an accelerator, an encoder/decoder, one or more antennas, a processor and memory.

7. The device of claim 1, further comprising one or more wireless radios.

8. The device of claim 1, further comprising a low-power wake-up radio power manager configured to control operation of a low-power wake-up radio.

9. The device of claim 1, configured to one or more of save power and improve connectivity for the registered station.

10. A non-transitory computer-readable information storage media, having stored thereon instructions, that when executed by a processor perform a wireless communication method, for a wireless communications device, comprising:
receiving from a receiver a discovery request from a low-power wake-up radio (LP-WUR) equipped device;
registering the LP-WUR equipped device, wherein the LP-WUR equipped device is allowed to enter a low-power mode using a low-power wake-up radio upon registration completion; and
advertising on behalf of the LP-WUR equipped device while the LP-WUR equipped device is in a low power mode.

11. The media of claim 10, further comprising receiving a request for further information from one or more other stations.

12. The media of claim 11, wherein a wake-up trigger causes a wake-up packet to be sent to the registered station.

13. The media of claim 10, wherein the device acts as an advertising proxy for the registered station.

14. The media of claim 10, wherein the device provides a low-power service discovery for the registered station.

15. The media of claim 10, further comprising communicating on one or more wireless radios.

16. The media of claim 10, further comprising controlling operation of a low-power wake-up radio.

17. The media of claim 10, wherein the device is configured to one or more of save power and improve connectivity for the LP-WUR equipped device.

18. A wireless communications device, comprising:
means for receiving from a receiver a discovery request from a low-power wake-up radio (LP-WUR) equipped device;
means for registering the LP-WUR equipped device, wherein the LP-WUR equipped device is allowed to enter a low-power mode using a low-power wake-up radio upon registration completion;
means advertising on behalf of the LP-WUR equipped device while the LP-WUR equipped device is in a low power mode; and
waking-up the LP-WUR equipped device when a request for further information is received for the LP-WUR equipped device.

19. A method for operating a wireless communications device comprising:
receiving from a receiver a discovery request from a low-power wake-up radio (LP-WUR) equipped device;
registering the LP-WUR equipped device, wherein the LP-WUR equipped device is allowed to enter a low-power mode using a low-power wake-up radio upon registration completion;
advertising on behalf of the LP-WUR equipped device while the LP-WUR equipped device is in a low power mode; and
waking-up the LP-WUR equipped device when a request for further information is received for the LP-WUR equipped device.
